(19) United States
(12) Patent Application Publication
(10) Pub. No.: US 2018/0172047 A1
(43) Pub. Date: Jun. 21, 2018

(54) CONDUCTIVE SUPPORT, TOOL FOR FITTING SAID CONDUCTIVE SUPPORT, METHOD FOR FITTING SAID CONDUCTIVE SUPPORT ON AN AIRCRAFT STRUCTURE AND AIRCRAFT STRUCTURE PROVIDED WITH SAID CONDUCTIVE SUPPORT

(71) Applicant: AIRBUS OPERATIONS (S.A.S.), Blagnac (FR)

(72) Inventors: Sebastien CLEMENTE, Colomiers (FR); Yannick LABROUSSE, Toulouse (FR); Didier SEKULA, Quint-Fonsegrives (FR)

(73) Assignee: AIRBUS OPERATIONS (S.A.S.), Blagnac (FR)

(21) Appl. No.: 15/841,939

(22) Filed: Dec. 14, 2017

(30) Foreign Application Priority Data
Dec. 20, 2016 (FR) 1662829

(51) Int. Cl. F16B 11/00; H01R 4/64

(52) U.S. Cl. CPC F16B 11/006; H01R 4/64

(57) ABSTRACT

A conductive support is disclosed which is configured to be fixed, thanks to an electrically conductive glue, on a surface of a metal structure and which includes an insert made from an electrical material which includes a first end face configured to be pressed against the surface of the structure and a second end face allowing the temporary fixing of an electrical element; and a body which includes a contact face coplanar with the first end face of the insert and which extends completely around the first end face of the insert.

The present application relates to a conductive support, to a tool for fitting said conductive support, to a method for fixing said conductive support on an aircraft structure and to an aircraft structure provided with said conductive support.

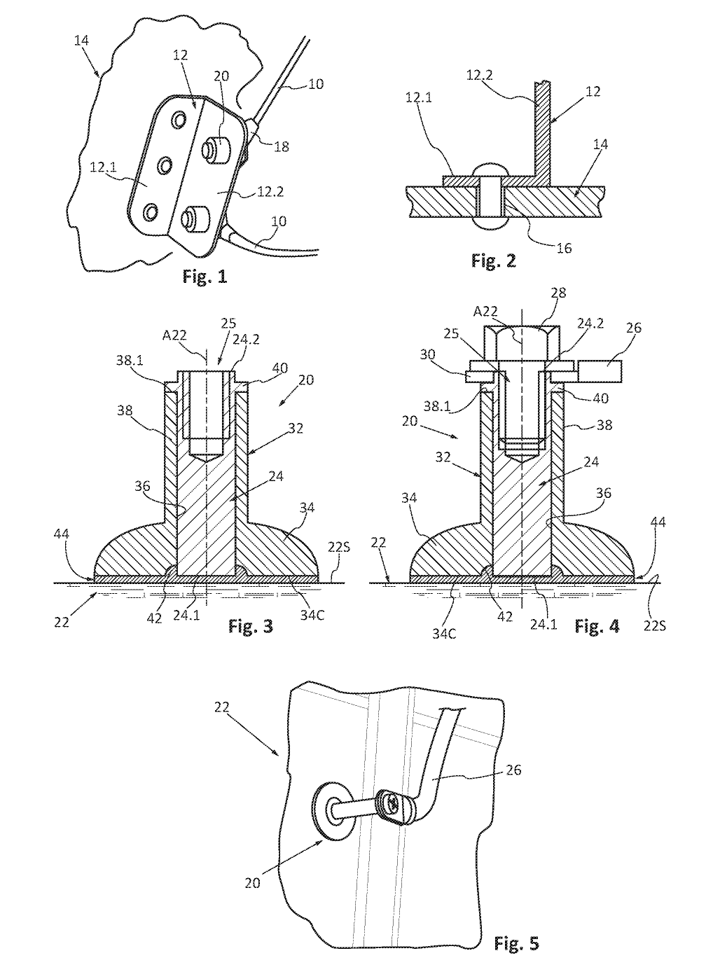

To carry out certain tests in an aircraft, it is necessary to temporarily connect electrical elements to the structure of the aircraft. As illustrated in FIGS. 1 and 2, the electrical elements are connected by a conductive cable 10 to a conductive support 12 which itself is connected to the structure of the aircraft 14.

According to an embodiment, the conductive support 12 is in the form of an L-shaped metal bracket, a first wing 12.1 of which is connected to the structure of the aircraft 14. To temporarily fix the conductive support 12 on the structure of the aircraft 14, this structure comprises several through-holes 16 for fixing the conductive support 12 by screwing or riveting.

The conductive cable 10 comprises, at one of the ends thereof, a lug 18 connected by a screw 20 to the conductive support 12 which has at least one hole on the second wing 12.2 configured to allow the screwing of the screw 20.

At the end of the tests, when the conductive support 10 is removed, the through-holes 16 produced in the structure of the aircraft 14 in order to fix the conductive support 10 remain. The aim of the present invention is to overcome the disadvantages of the prior art by proposing a conductive support which is temporarily fixed on the structure of an aircraft without through-holes.

To this end, the object of the invention is a conductive support configured to be fixed on a surface of a metal structure and comprising at least one anchoring zone provided for the temporary fixing of an electrical element, characterized in that it comprises:
an insert made from an electrically conductive material which includes a first end face configured to be pressed against the surface of the structure and the anchoring zone at a distance from the first end face and positioned approximately perpendicular to the first end face,
a body which includes a contact face coplanar with the first end face of the insert and which extends completely around the first end face of the insert,
an electrically conductive glue spread on the first end face of the insert and the contact face of the body.

This solution makes it possible to temporarily connect an electrical element to the structure of an aircraft without piercing the structure.

According to another feature, the conductive support comprises a peripheral trench on the contact face of the body, positioned at the periphery of the insert.

According to embodiments of the conductive support:
the contact face has a ring shape, coaxial with the first end face of the insert, with a diameter at least three times greater than that of the first end face of the insert;
the insert has a length substantially equal to the diameter of the contact face;
the body comprises a base which has the contact face and a tubular portion which is placed on top of the base, which surrounds the insert and which has a first end connected to the base and a second end which has an end face;
the insert comprises a flange bearing against the end face of the tubular portion of the body.

Another object of the invention is a tool for fitting a conductive support according to the invention, characterized in that it comprises a housing configured to at least partially receive the conductive support and at least one bearing surface coplanar with the contact face and the first end face of the insert when the conductive support is positioned in the housing. According to other features of the fitting tool:
each bearing surface comprises an adhesive making it possible to temporarily connect the fitting tool to a structure and to remove the fitting tool once the electrically conductive glue has set;
each adhesive comprises a peelable protective film.

Another object of the invention is a method for fitting a conductive support according to the invention on a surface of a structure, characterized in that it comprises a step for installing the conductive support in the housing of the fitting tool, a step for applying the fitting tool against the surface of the structure and a step for taking off the fitting tool once the electrically conductive glue has set.

Finally, another object of the invention is an aircraft structure comprising a conductive support according to the invention.

Other features and advantages will emerge from the following description of the invention, which is given solely by way of example, with reference to the appended drawings in which:

FIG. 1 is a perspective view of a conductive support which illustrates an embodiment of the prior art,

FIG. 2 is a section of the conductive support that can be seen in FIG. 1,

FIG. 3 is a longitudinal section of a conductive support which illustrates an embodiment of the invention, without a conductive cable connected,

FIG. 4 is a longitudinal section of a conductive support which illustrates an embodiment of the invention, to which a conductive cable is connected,

FIG. 5 is a perspective view of the conductive support that can be seen in FIG. 4,

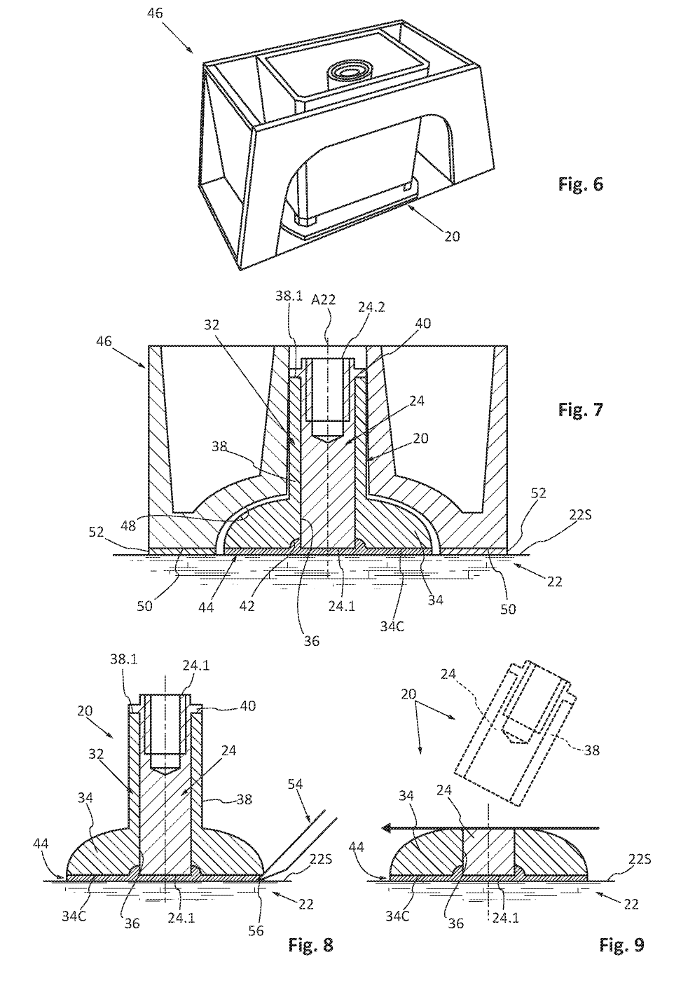

FIG. 6 is a perspective view of a tool configured to fix a conductive support,

FIG. 7 is a section of the tool that can be seen in FIG. 6,

FIG. 8 is a longitudinal section of a conductive support which illustrates a first procedure for removing it, and

FIG. 9 is a longitudinal section of a conductive support which illustrates a second procedure for at least partially removing it.

In FIGS. 3 and 4, a conductive support 20 is attached onto a structure 22 of an aircraft. The structure 22 of the aircraft comprises a substantially planar surface 22S against which the conductive support 20 is pressed.

The structure of the aircraft 22 is metal and corresponds to zero potential or to the earth of an electrical apparatus of the aircraft.

The conductive support 20 comprises a metal insert 24, of cylindrical shape which has a first end face 24.1 configured to be in contact with the surface 22S of the structure 22 and a second end face 24.2 configured to make it possible to electrically connect an electrical element 26, in particular an electrical cable, to the metal insert 24.

The insert 24 is not necessarily metal. In all cases, it is produced from an electrically conductive material.

For the remainder of the description, a longitudinal direction is parallel to the axis A22 of the insert 24. The first and second end faces 24.1 and 24.2 are perpendicular to the longitudinal direction. When the conductive support 20 is fitted onto the structure 22 of the aircraft, the longitudinal direction is perpendicular to the surface 22S.

According to an embodiment, the second end face 24.2 comprises a tapped hole for screwing a screw 28 in order to connect a lug 30 provided at the end of an electrical cable to the insert 24 of the conductive support 20.

Regardless of the embodiment, the insert 24 made from an electrically conductive material comprises at least one anchoring zone 25 at a distance from the first end face 24.1, positioned approximately perpendicular to the first end face 24.1 and configured to allow the temporary fixing of an electrical element 26.

The conductive support 20 also comprises a body 32 in which the insert 24 is positioned. According to an embodiment, the body 32 is made of plastic. It is obtained by overmoulding on the insert 24 or by a 3D printing technique.

The body 32 comprises a base 34 which comprises a contact face 34C coplanar with the first end face 24.1 of the insert 24. Thus, when the conductive support 20 is affixed on the surface 22S of the structure, the contact face 34C and the end face 24.1 are pressed against the surface 22S of the structure 22.

The base 34 comprises a through-hole 36 which opens at the contact face 34C and which has a diameter equal to that of the insert 24.

Preferably, the contact face 34C is ring shaped with a diameter at least three times greater than that of the first end face 24.1 of the insert 24. The contact face 34C is substantially coaxial with the first end face 24.1 of the insert 24. According to this configuration, the first end face 24.1 of the insert 24 is positioned in the middle of the contact face 34C. According to an embodiment, the base 34 has sections, in longitudinal planes (passing through the axis A22), having the approximate shape of a half-ellipse, the height of the base 34 (dimension taken along the longitudinal direction) being substantially equal to the diameter of the insert 24.

The body 32 also comprises a tubular portion 38 which is placed on top of the base 34 and surrounds the insert 24. This tubular portion 38 comprises a first end connected to the base 34 and a second end which has an end face 38.1 substantially perpendicular to the longitudinal direction. This tubular portion 38 extends the through-hole 36 which opens firstly at the contact face 34C and secondly at the end face 38.1.

Of course, the invention is not limited to this geometry for the body 32. Preferably, the body 32 comprises a contact face 34C coplanar with the end face 24.1 of the insert 24 and which extends completely around the end face 24.1 of the insert 24.

The insert 24 has a length (dimension taken parallel to the longitudinal direction) substantially equal to the diameter of the contact face 34C. According to other configurations, the insert 24 can be longer or shorter than the diameter of the contact face 34C. The insert 24 is positioned in the body 32 such that the first end face 24.1 and the contact face 34C are coplanar.

According to an embodiment, the insert 24 has a length greater than that of the through-hole 36 and comprises a flange 40 bearing against the end face 38.1 of the tubular portion 38 of the body 32. This flange 40 makes it possible to immobilize the insert 24 with respect to the body 32 in the longitudinal direction such that the first end face 24.1 and the contact face 34C are coplanar.

According to a configuration, the through-hole 36 comprises an enlargement at the contact face 34C. Thus, the conductive support 20 comprises a peripheral trench 42 on the contact face 34C, positioned at the periphery of the metal insert 24, between the insert 24 and the body 32.

According to a feature of the invention, the conductive support 20 is connected to the structure 22 of the aircraft by an electrically conductive glue 44 which provides the electrical continuity between the insert 24 and the structure 22 of the aircraft.

By way of example, the electrically conductive glue 44 is an epoxy glue comprising electrically conductive fillers.

The electrically conductive glue 44 is spread uniformly over the first end face 24.1 of the insert 24 and the contact face 34C of the body 32. The fact that the second end face 24.2 of the insert which corresponds to the anchoring zone 25 for the electrical element 26 is spaced apart from the structure 22 of the aircraft and located perpendicular to the centre of the contact face 34C reinforces the strength of the gluing connection between the conductive support 20 and the structure 22 of the aircraft, the electrically conductive glue 44 being mainly subjected to tensile stresses rather than shearing stresses.

In the presence of a peripheral trench 42 around the end face 24.1 of the insert 24, the electrically conductive glue 44 fills said peripheral trench 42 which tends to increase the strength of the gluing connection between the conductive support 20 and the structure 22 of the aircraft.

FIGS. 6 and 7 show a fitting tool 46 for installing a conductive support 20 according to the invention.

This fitting tool 46 comprises a housing 48 configured to at least partially receive the conductive support 20 and at least one bearing surface 50 coplanar with the contact face 34C and with the first end face 24.1 of the insert 24 when the conductive support 20 is positioned in the housing 48. According to an embodiment, the fitting tool 46 comprises two bearing surfaces 50 arranged on either side of the housing 48. Each bearing surface 50 comprises an adhesive 52 making it possible to temporarily connect the tool 46 to the structure 22 of the aircraft and to remove the tool 46 once the electrically conductive glue 44 has set. According to an embodiment, the adhesive 52 is covered with a peelable protective film to be removed before applying the tool 46 against the surface 22S of the structure 22 of the aircraft.

The housing 48 and the bearing surface or surfaces 50 are arranged such that the first end face 24.1 and the contact face 34C are held in contact with the structure 22 of the aircraft when the tool 46 is positioned on said structure 22 of the aircraft.

The fitting tool 46 is made of plastic and is largely hollowed out in order to reduce the mass thereof.

The method for fitting the conductive support 20 comprises a step for installing the conductive support 20 in the housing 48 of the fitting tool 46 such that the first end face 24.1 and the contact face 34C of the conductive support 20 are coplanar with the bearing surfaces 50 of the tool 46, a step for taking off the protective films for the adhesive 52 of the tool 46, a step for applying the tool 46 against the surface 22S of the structure of the aircraft at the desired location and a step for taking off the fitting tool 46 once the electrically conductive glue 44 has set.

The conductive support 20 can then be used.

The fitting method can comprise a step for coating the first end face 24.1 and the contact face 34C of the conductive support 20 with the electrically conductive glue 44 when the conductive support 20 is positioned in the fitting tool 46 and before the latter is applied against the surface 22S of the structure 22.

After having been used as a conductive support 20 to connect an electrical element 26 to the structure 22 of the aircraft, the conductive support 20 can be used as a support to connect an element to the structure 22 of the aircraft or it can be at least partially removed.

According to a first procedure illustrated in FIG. 8, the conductive support 20 is entirely removed. In this case, an implement 54 with a sharp end 56 is used to cut the electrically conductive glue 44 and separate the conductive support 20 from the structure 22 of the aircraft.

According to a second procedure illustrated in FIG. 9, the conductive support 20 is partially removed. In this case, an implement is used to cut the conductive support 20. According to this procedure, only the base 34 and the part of the insert 24 present in the base remain attached to the structure 22 of the aircraft, the tubular portion 38 of the body 32 and the part of the insert 24 which protrudes from the base 34 being cut.

1. Conductive support configured to be fixed on a surface of a metal structure and comprising:
at least one anchoring zone provided for temporary fixing of an electrical element;
an insert made from an electrically conductive material which includes a first end face configured to be pressed against the surface of the structure and the anchoring zone at a distance from the first end face and positioned approximately perpendicular to the first end face;
a body which includes a contact face coplanar with the first end face of the insert and which extends completely around the first end face of the insert; and
an electrically conductive glue spread on the first end face of the insert and the contact face of the body.

2. Conductive support according to claim 1, wherein it comprising:
a peripheral trench on the contact face of the body, positioned at the periphery of the insert.

3. Conductive support according to claim 1, wherein the contact face has a ring shape, coaxial with the first end face of the insert, with a diameter at least three times greater than that of the first end face of the insert.

4. Conductive support according to claim 3, wherein the insert has a length substantially equal to the diameter of the contact face.

5. Conductive support according to claim 1, wherein the body comprises:
a base which has the contact face and a tubular portion which is placed on top of the base, which surrounds the insert and which has a first end connected to the base and a second end which has an end face and in that the insert comprises a flange bearing against the end face of the tubular portion of the body.

6. Tool for fitting a conductive support according to claim 1, comprising:
a housing configured to at least partially receive the conductive support and at least one bearing surface coplanar with the contact face and the first end face of the insert when the conductive support is positioned in the housing.

7. Fitting tool according to claim 6, wherein each bearing surface comprises:
an adhesive selected to temporarily connect the fitting tool to a structure and to remove the fitting tool once the electrically conductive glue has set.

8. Fitting tool according to claim 7, wherein each adhesive comprises:
a peelable protective film.

9. Method for fitting a conductive support configured to be fixed on a surface of a metal structure and having: at least one anchoring zone provided for temporary fixing of an electrical element; an insert made from an electrically conductive material which includes a first end face configured to be pressed against the surface of the structure and the anchoring zone at a distance from the first end face and positioned approximately perpendicular to the first end face; a body which includes a contact face coplanar with the first end face of the insert and which extends completely around the first end face of the insert; and an electrically conductive glue spread on the first end face of the insert and the contact face of the body, wherein the method comprises:
installing the conductive support in the housing of the fitting tool;
applying the fitting tool against the surface of the structure; and
taking off the fitting tool once the electrically conductive glue has set.

10. A conductive support according to claim 1, in connection with an aircraft structure.
